(19) United States
(12) Patent Application Publication
(10) Pub. No.: US 2013/0224580 A1
(43) Pub. Date: Aug. 29, 2013

(54) LITHIUM BATTERY HAVING ELECTRODE TABS WITH SAFE MODIFICATION

(71) Applicants: Jing-Yih CHERNG, Gueishan Township (TW); Hsuan-Fu WANG, Gueishan Township (TW); Te-Chuan LAI, Gueishan Township (TW); Hung-I TSAI, Gueishan Township (TW); Chih-Chao LIN, Gueishan Township (TW)

(72) Inventors: Jing-Yih CHERNG, Gueishan Township (TW); Hsuan-Fu WANG, Gueishan Township (TW); Te-Chuan LAI, Gueishan Township (TW); Hung-I TSAI, Gueishan Township (TW); Chih-Chao LIN, Gueishan Township (TW)

(73) Assignee: AMITA TECHNOLOGIES INC LTD.

(21) Appl. No.: 13/404,013

(22) Filed: Feb. 24, 2012

(51) Int. Cl. H01M 4/64

(52) U.S. Cl. 429/211

(57) ABSTRACT

The invention relates to a lithium battery having electrode tabs with safe modification. The lithium battery comprises a cathode plate having a cathode electrode tab, an anode plate having an anode electrode tab, and a separator strip interposed between the cathode plate and the anode plate, wherein the cathode electrode tab and the anode electrode tab have insulation layers coating on predetermined areas.

### BACKGROUND OF THE INVENTION

1. Field of the invention

The invention relates to electrode tabs of lithium battery and in particular to safe modification for electrode tabs of lithium battery.

2. Description of the related art

The lithium battery has been developed vigorously and applied in various field from portable electronic products to electric vehicles. The lithium battery having high capacity and high power has been developed continuously. However, it causes a complicated design of battery and danger. The general methods includes using safety valve, resistor member with positive temperature coefficient, current interrupt device, radiator in battery design; and monitoring the change of voltage, electricity and temperature of each unit of battery by an electric circuit board. However, the above methods of safety design cannot completely prevent the lithium battery from the internal short.

There are several factors to cause internal short, for example, contaminant in the process, over-charging, over-discharging, improperly heating and external pressure resulting in crack and deformation of structure. The degree of the internal short and the damage are different relying on the different factors. Definitely, the selection of cathode material, anode material, separator strip and electrolyte are the main factors to affect the damage degree of the battery.

It never becomes the best method to solve the problem of the lithium battery safety by try and error. It should focus on the materials of basic components of battery, design of battery structure and arrangement of stack of battery units. The two front items may be developed by the factories that manufacture the cells of batteries, and the last item combining with battery management and monitoring systems may be developed by the assembly factories. The best method for preventing from inefficiency is to establish a thermal runaway model of the lithium battery according to basic theory.

According to Journal of power sources 194(2009)550-557, there are four typical internal shorts that release energy and rise temperature as the internal short happens. Four typical internal shorts are type I: the internal short happening between two electricity collectors; type II: the internal short happening between anode electricity collector (copper) and cathode active substance; type III: the internal short happening between cathode electricity collector (aluminum) and anode active substance; and type IV: the internal short happening between cathode active substance and anode active substance wherein type III may release the largest energy and rise the highest temperature, showing a most serious internal short. Therefore, there is a need to enhance the safety of battery by a protective mechanism that may prevent the electrode tab of the cathode plate (aluminum) from contacting the anode active substance to cause the internal short as the separator contracts.

Therefore, the inventor conducted researches according to the scientific approach in order to improve and resolve the above drawback, and finally proposed the present invention, which is reasonable and effective.

### SUMMARY OF THE INVENTION

It is an object of present invention to provide a lithium battery having electrode tabs with safe modification.

In order to achieve the above object, there is provided a lithium battery having electrode tabs with safe modification according to the present invention, comprising a cathode plate having a cathode electrode tab, an anode plate having an anode electrode tab, and a separator strip interposed between the cathode plate and the anode plate, wherein the cathode electrode tab and the anode electrode tab have insulation layers coating on predetermined areas. The predetermined area has height of 1 to 2 mm from the bottom of the cathode electrode tab and the anode electrode tab, but not to 3 mm because it may affect the welded portion for welding a conductive stem.

The lithium battery having electrode tabs with safe modification according to the present invention can avoid a rapid hazard by a mechanism of suppressing the voltage sharply down to zero with the voltage dropping slowly and the temperature rising slowly when internal short of the cell continuously occurred. Therefore, it can prevent thermal runaway of the lithium battery.

### BRIEF DESCRIPTION OF THE DRAWINGS

FIG. 1 shows a schematic view of a cathode plate, an anode plate and a separator strip of a lithium battery in a collective status of a preferred embodiment of the invention.

FIG. 2 shows a graph of voltage change with time of high temperature test of 130° C. of a lithium battery having a tab without safe modification and a lithium battery having a tab with safe modification of a preferred embodiment of the invention.

FIG. 3 shows a graph of voltage change with time of high temperature test of 150° C. of a lithium battery having a tab without safe modification and a lithium battery having a tab with safe modification of a preferred embodiment of the invention.

FIG. 4 shows a graph of temperature change with time of nail penetration test of a lithium battery having a tab with safe modification of a preferred embodiment of the invention.

FIG. 5 shows a graph of temperature change with time of nail penetration test of a lithium battery having a tab without safe modification.

### DETAILED DESCRIPTION OF THE INVENTION

The technical content of invention will be explained in more detail below with reference to a few figures. However, the figures are intended solely for illustration and not to limit the inventive concept.

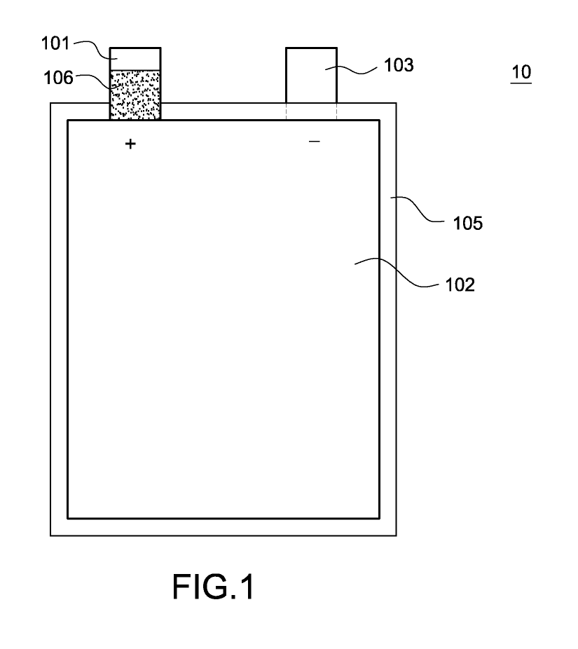

FIG. 1 shows a schematic view of a cathode plate, an anode plate and a separator strip of a lithium battery in a collective status of a preferred embodiment of the invention. As shown in FIG. 1, a lithium battery 10 having a tab with safe modification comprises a cathode plate 102 having a cathode electrode tab 101, an anode plate (not shown in FIG. 1) having an anode electrode tab 103, and a separator strip 105 interposed between the cathode plate 102 and the anode plate, wherein the cathode electrode tab 101 has an insulation layer 106 on a predetermined area and the anode electrode tab 103 also has an insulation layer (not shown in FIG. 1) on a predetermined area. The predetermined area has height of 1 to 2 mm from the bottom of the cathode electrode tab and the anode electrode tab, but not to 3 mm

Next, a method for manufacturing a lithium battery 10 having a tab with safe modification includes steps of coating an insulation layer on a cathode electrode tab 101 of a cathode plate 102; and winding a stack of the cathode plate 102 having cathode electrode tab 101 and the anode plate having an anode electrode tab 103 to form the lithium battery 10, for example, Z winding type lithium battery. After winding the stack of the cathode plate 102 and the anode plate, the lithium battery 10 is activated. The insulation layer includes polyethylene oxide), aluminum oxide and ethanol with parts of 1˜2:2˜4:50˜100, preferred parts of 2:4:100. The insulation layer has height of 1 to 2 mm from the bottom of the cathode electrode tab and the anode electrode tab. The insulation layer has a thickness of 1-5 μm.

Next, the lithium battery 10 having a tab with safe modification proceeds a safety test. Also, the lithium battery 10 is disassembled to observe the internal change thereof after the safety test.

(High temperature test of 130° C.)

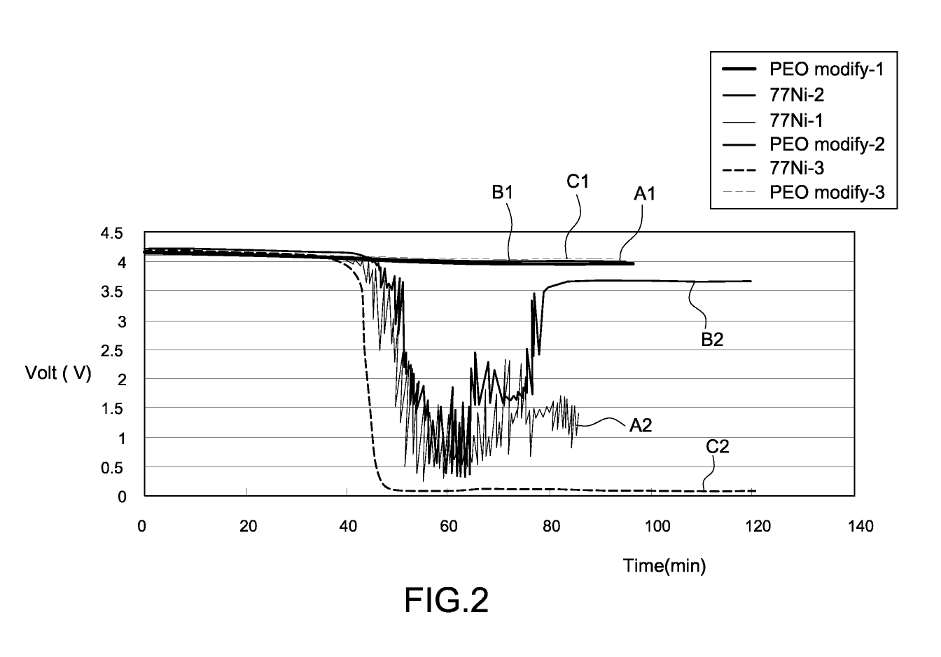

The lithium battery is placed in a oven with temperature rising to 130° C. and retaining 50 minutes. As shown in FIG. 2, curves A1, B1 and C1 represent three sets of the lithium battery having a tab with safe modification but curves A2, B2 and C2 represent three sets of the lithium battery having a tab without safe modification. The voltage values of curves A1, B1 and C1 are stably kept at about 4V during the test, but the voltage values of curves A2, B2 and C2 are not stable and move up and down. Curve C2 is even down to 0V.

The three sets of the lithium battery having a tab without safe modification should have serious internal short based on the result that the voltages are not stable. On the other hand, the three sets of the lithium battery having a tab with safe modification should only have minor internal short based on the result that the voltages are stable. Also, it can be observed that the separator of the lithium battery having a tab without safe modification is contracted under the anode plate to cause the internal short happening between cathode electricity collector (aluminum) and anode active substance. In contrast, the lithium battery having a tab with safe modification has a minor internal short and stable voltage because the tab has safe modification.

The lithium battery is disassembled to observe the internal change thereof after the 130° C. test. It can be found that the separator the lithium battery having a tab without safe modification is contracted seriously under the cathode tab and changes color, even produces stains on the cathode plate. It is obvious the lithium battery having a tab without safe modification has a serious internal short. In contrast, the separator of the lithium battery having a tab with safe modification is contracted slightly and does not change color, and does not produce black dots on the cathode plate. Therefore, the lithium battery having a tab with safe modification has a minor internal short.

(High temperature test of 150° C.)

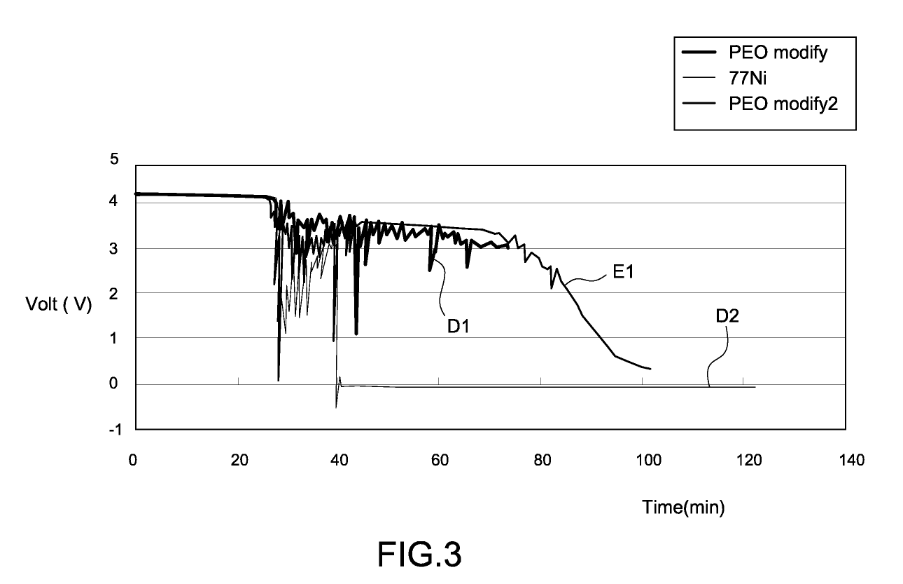

The lithium battery is placed in a oven with temperature rising to 150° C. and retaining 50 minutes. As shown in FIG. 3, curves D1 and E1 represent two sets of the lithium battery having a tab with safe modification but curve D2 represents the lithium battery having a tab without safe modification. The voltage values of curves D1 and E1 are stably kept at about 3V during the test, but the voltage value of curve D2 is down to 0V after 40 minutes. Also, it can be observed that the lithium battery having a tab without safe modification happens bag-breaking and catching fire under 150° C. due to the internal short. In contrast, the lithium battery having a tab with safe modification has a minor internal short and stable voltage because the tab has safe modification.

Also, it can be observed that the separator of the lithium battery having a tab without safe modification is contracted under the anode plate to cause the internal short happening between cathode electricity collector (aluminum) and anode active substance. In contrast, the lithium battery having a tab with safe modification has a minor internal short and stable voltage because the tab has safe modification.

(Nail penetration test)

The nail penetration test is a durable test of cell of battery under the internal short, which determines whether the battery can pass the test by happening explosion or catching fire. The test may use a tungsten nail with a tip diameter of 5 mm to press but not to penetrate the housing of the battery by controlling the forward velocity of 10 mm/s. Accordingly, the cathode plate and the anode plate are pressed to form an internal short in a local area. The tungsten nail stops forward when measuring a transient voltage declining rate of a battery equal to or higher than 100 mV. The changes of appearance, voltage and temperature of the battery are observed. Also, IR image thermometer can be used to observe the temperature diffusion and distribution of the battery for understanding the internal short of the battery. Therefore, it is a relatively simple method of short circuit test.

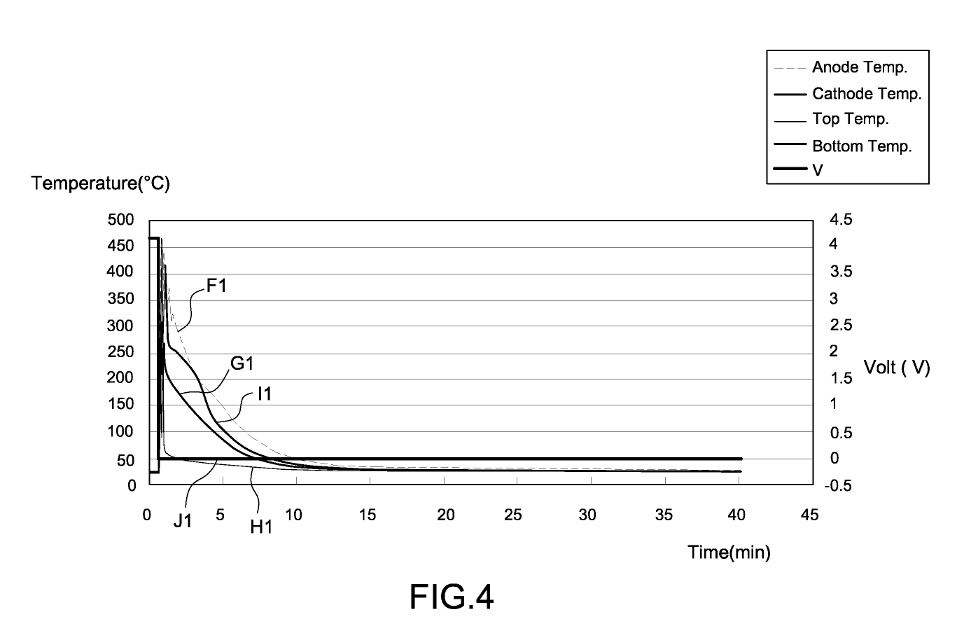

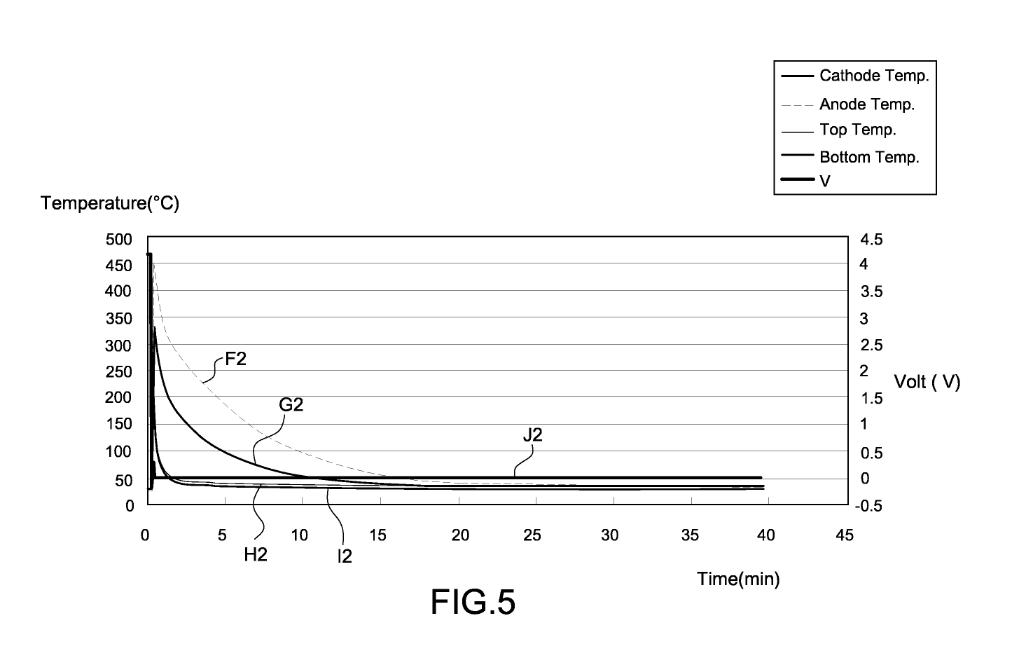

FIG. 4 shows a graph of temperature change with time of nail penetration tem of a lithium battery having a tab with safe modification of a preferred embodiment of the invention. FIG. 5 shows a graph of temperature change with time of nail penetration test of a lithium battery having a tab without safe modification. As shown in FIGS. 4 and 5, curves F1, G1, H1, I1 and J1 are not obviously different to curves F2, G2, H2, I2 and J2 in the nail penetration test. Those curves have the highest temperature about 450° C. However, it can be found that the lithium battery having a tab with safe modification happens bag-breaking and catching fire slower than the lithium battery having a tab without safe modification. The amount of flame produced from the lithium battery having a tab with safe modification is less than the amount of flame produced from the lithium battery having a tab without safe modification.

Therefore, it can be found that the lithium battery having a tab with safe modification is safer than the lithium battery having a tab without safe modification based on the change of voltage and temperature of the high temperature tests of 130° C. or 150° C. Also, it can be observed that the lithium battery having a tab without safe modification may happen bag-breaking and catching fire under 150° C. due to the internal short.

The lithium battery is disassembled to observe the internal change thereof after the 130° C. test. It can be found that the separator the lithium battery having a tab without safe modification is contracted seriously under the cathode tab and changes color, even produces stains on the cathode plate. Also, it can be observed that the lithium battery having a tab without safe modification happens bag-breaking and catching fire under 150° C. due to the internal short. Therefore, the mechanism of the internal short should be two stages that firstly the separator is contracted due to the external high temperature that causes the tab of cathode plate to contact with anode plate bringing short, and then the internal short gets serious to increase the heat generation and the separator is contracted more seriously to cause the internal short getting serious, even igniting electrolyte to catch fire.

In the nail penetration test, the curves indicating the lithium battery having a tab with safe modification are not obviously different to the curves indicating the lithium battery having a tab without safe modification in the temperature change. However, it can be found that the lithium battery having a tab with safe modification happens bag-breaking and catching fire slower than the lithium battery having a tab without safe modification. The amount of flame produced from the lithium battery having a tab with safe modification is less than the amount of flame produced from the lithium battery having a tab without safe modification.

Therefore, it can enhance battery safety at high temperature and reduce the internal short by coating an insulation layer including aluminum oxide on tabs.

The invention is not limited to these embodiments, but various variations and modifications may be made without departing from the scope of the invention.

What is claimed is:

1. A lithium battery having electrode tabs with safe modification comprising:
a cathode plate having a cathode electrode tab;
an anode plate having an anode electrode tab; and
a separator strip interposed between the cathode plate and the anode plate, wherein the cathode electrode tab and the anode electrode tab have insulation layers coating on predetermined areas.

2. The lithium battery having electrode tabs with safe modification as claimed in claim 1, wherein the insulation layer includes aluminumoxide.

3. The lithium battery having electrode tabs with safe modification as claimed in claim 1, wherein the insulation layer includes poly(ethylene oxide) aluminum oxide and ethanol with parts of 1˜2:2˜4:50˜100

4. The lithium battery having electrode tabs with safe modification as claimed in claim 1, wherein the predetermined area has height of 1 to 2 mm from the bottom of the cathode electrode tab and the anode electrode tab.

5. The lithium battery having electrode tabs with safe modification as claimed in claim 1, wherein the insulation layer has a thickness of 1 to 5 μm.
